(19) United States
(12) Patent Application Publication
(10) Pub. No.: US 2014/0301675 A1
(43) Pub. Date: Oct. 9, 2014

(54) Packaging for single-handed manipulation

(71) Applicant: Jan-Niklas KELTSCH, BAD SCHWARTAU (DE)

(72) Inventor: Jan-Niklas Keltsch, Bad Schwartau (DE)

(21) Appl. No.: 14/248,402

(22) PCT Filed: Oct. 29, 2012
(86) PCT No.: PCT/EP2012/071419

§ 371 Date: Apr. 9, 2014

(30) Foreign Application Priority Data
Oct. 31, 2011 (DE) 102011085484.3
Oct. 31, 2011 (DE) 102011085485.1

(51) Int. Cl. B65D 33/16; B31B 1/90; B65D 33/18

(52) U.S. Cl. CPC B65D 33/16; B65D 33/18; B31B 1/90
USPC 383/211; 383/42; 493/213

(57) ABSTRACT

To provide a particularly easy to-use packaging, the packaging according to the invention comprises a first side panel and a second side panel, wherein the first and the second side panel form an opening of an interior of the packaging for receiving the product, a flap, which is arranged at the first side panel and comprises a recess that is configured to receive a finger, at least one spreading element for spreading the opening, and one coupling element configured to close the opening, wherein the coupling element is arranged on an outer side of the flap and/or the first side panel.

The invention relates to a packaging and a method for producing a packaging.

Packaging with different closing mechanisms is known. Such mechanisms may be Velcro closures, zippers, and clip closures, adhesive closures etc. The packaging may be configured for different applications: for use with food (especially in the kitchen), in industry for packaging of products, in the medical field for sterile packaging etc.

An object of the present invention is to provide an easy-to-use packaging for a variety of applications.

In accordance with an aspect of the invention, the problem is solved by a packaging for receiving a product, comprising: a first side panel and a second side panel, wherein said first and second side panel form an opening of an interior of the packaging for receiving the product, a flap that is configured to be placed on the first side panel and which comprises a recess for receiving a finger, a spreading element for spreading the opening, and a coupling element to close the opening, wherein the coupling element is configured to be placed at the outer side of the flap and/or of the first side panel.

A packaging closure according to the invention may thus be operated—that means to be opened or closed—with one hand.

The invention is, inter alia, based on the idea to provide a packaging in which the flap is designed as a double flap and which is suitable to receive a product comprising an adhesive or bonding surface by means of the double flap. This idea is also advantageous for a product which—when in contact with the double flap—has a high coefficient of friction.

By the term “double flap” it is meant that the flap is designed double-layered. The double flap has a first and a second layer (“layer” is also referred to as “flap”), wherein the first and second layer are connected at one side or edge. In one embodiment, it is also possible that the two layers are connected to each other at two opposite sides. Preferably, the first flap (or “first layer”) is connected to the first side panel. Preferably, the first and the second flap are integrally (ie, from one piece of material) formed. Preferably a fold is located between the first and the second flap. Preferably, the first and the second flap and the first side panel are integrally formed. Preferably, the second layer (or “second flap”) of the double flap is the one facing the opening of the package.

In so far as in the present application the term “flap” is used and/or a single flap is shown in the figures, a two layer flap (thus a double flap) can (but need not to) be meant.

The invention is based on the insight that the one-handed operation is obtained particularly advantageous in that by activating the spreading element (preferably by pressing with the thumb and middle finger of a user) along its longitudinal axis and by pulling the flap wherein a finger (preferably the index finger) of said user is placed in the recess, the opening of the packaging will be released and clamped to receive the product. The direction of pulling of the flap is substantially opposite to that direction of the movement of the product when received through the opening by the interior of the packaging. The packaging is held stable and opened under normal use at three points in the user's hand (thumb, middle finger, index finger), thus making it possible to insert the product in the interior of the packaging particularly simple and reliably.

The coupling element is configured to close the opening when the flap is arranged in the interior. In this way, it is advantageously achieved that the flap, which has possibly got in contact with the product inserted in the interior and thus may be dirty, can, according to the intended use of the packaging, also be disposed of in the interior of the package.

According to the invention it is achieved that upon the introduction of, for example, an adhesive product, such product sticks on to the double flap and—aided by gravity or force applied by the user—the double flaps moves or glides into the interior. The first and second layer slides on one another (or roll off each other), so that the adhesion of the product during the insertion into the opening does not affect negatively. In embodiments in which an coupling-element-flap is provided with an adhesive element—as explained hereinafter—it is also advantageous in that the double flap is unwound from the adhesive element when the double flap—caused by the adhesion of the product—slides into the interior. This provided, in some preferred embodiments, the adhesive element is uncovered (“activated”) in order to close the opening.

The adhesive element may be arranged, in preferred embodiments, on the outer side of the double flap (that is the side of the flap far from the side facing the opening of the packaging). The coupling element is designed to seal the opening when the double flap is disposed in the interior. In this way, it is advantageously achieved that the double flap which has possibly got in contact with the product inserted in the interior and thus may be dirty, can, according to the intended use of the packaging, also be disposed of in the interior of the package. The double flap is “disposed of” in the interior after intended use and then the packaging is sealed. Also, it is advantageously achieved that after closing the packaging does not comprise any tabs or juts etc., which could possibly lead to an accidental re-opening by snagging or similar.

A packaging in accordance with the invention can advantageously be operated with a single hand; that means that the packaging can be opened, held open and preferably closed with a single hand. Of course, it is also possible to use the packaging with several hands or robot gripper arms or the like.

By the term “product” any element is meant that is to be introduced into the packaging. This may, for example, be an industrial product, a food product, waste, in particular a used hygiene product such as a tampon, a pad or a diaper, a material or cell sample, but also any other body that is to be packaged and if necessary removed from the packaging at a later stage.

When it is mentioned in the present application that the coupling element is placed on an outer side of the flap or double flap and/or of the first side panel, it is meant that the coupling element is arranged on a side of the first side panel and/or the flap that is opposite of the side of the opening of the packaging. The coupling element is, in preferred embodiments, which are explained in more detail below, placed on the outside of the packaging, preferably on the outside of the flap and/or the outside of the first side panel respectively. The coupling element may be connected to the flap and/or the first side panel, such as be formed integrally with it, but it can also be applied to an adhesive-element-flap which is placed on a side of the first side panel and/or the flap facing away from the opening of the packing.

It is also noted that in so far as said in the present application, the fact that the coupling element is arranged on the inside of the coupling-element-flap, it is meant that the coupling element is arranged on a side of the coupling-element-flap facing the opening of the package. With such an arrangement, in a preferred embodiment, the flap or double flap is arranged between the coupling element and the opening to advantageously prevent unintentional adhesion (or bonding) of the coupling element with the second side part. Preferred embodiments of an arrangement of the coupling element on the inside of the coupling-element-flap are explained below.

Further, it is also noted that in so far as said in the present application, the fact that a counter-coupling element is provided, which is arranged on an inner side of the second side panel, it is meant that the counter-coupling element is arranged on the second side panel's side facing the opening of the package side. Preferred embodiments of arrangements of the coupling-element on the inside of the second side panel are explained below.

In so far as a packaging with a clamping element is mentioned in the present application, embodiments are included, in which several spreading elements are provided, as explained with reference to preferred embodiments below.

The packaging in accordance with the invention is preferably used as follows: In an initial stage, the flap (or double flap) is positioned outside the interior, the user's hand holds the packaging in accordance with the invention with his thumb and middle finger at the spreading element(s). The index finger is placed in the recess of the flap and pulls on the flap (or double flap). This three-point-holding (thumb and middle finger on the spreading element and index finger in the recess) of the packaging allows the secure holding and clamping of the opening. The packaging is now opened and the product can be inserted. In preferred embodiments, within which the flap is a double flap, the adhesive product sticks to the second layer (the layer that is facing the interior) of the flap and pulls the double flap into the interior of the packaging.

The pulling force at the flap that is caused by the movement of the finger in the recess and the counterforce that is caused by the friction of the thumb and the middle finger on the spreading element, can allow the flap to be formed as a chute that can be used for inserting the product into the interior. For closing the packaging one (or multiple) finger(s) of preferably that hand that holds the packaging or of the hand that has placed the product into the packaging pushes the flap in the interior. The coupling element is, for example, activated by removing the flap from the area between the coupling element and the opening so that the coupling element closes the opening achieving a final state (flap is positioned in the interior).

Thus, the flap is positioned outside the opening in an initial state. The flap is configured to be pulled in the opposite direction as the movement of the product when inserting it into the interior. In the state of an opened packaging, the flap supports the simple, secure and clean insertion of the product in the packaging because the flap is spanned and serves as an area for receiving the, for example sticky, product and the recess of the flap preferably serves as a third holding point (the first and second holding point are the spreading elements at which the packaging is being held). Furthermore, the flap is designed to be pulled or pushed into the interior and hence disposed of after the product has been inserted into the interior of he packaging. The inventive coupling element serves the closing of the packaging in a final state.

Preferably, the (one-piece) flap or double-flap is arranged directly at the first side panel. Preferably the flap and the first side panel or the double-flap and the first side panel respectively are formed from one piece of material.

According to the invention, a packaging closure for a package is provided which is particularly easy to use. Particularly preferred and advantageous it is operated with one hand. Opening the packaging is advantageously carried out by simply pulling on the flap or double flap by means of a finger disposed in the recess of the flap. The introduction of the product is very simple and clean, because the flap can act as a kind of “slide” for the product when inserting it into the interior. Further, in a preferred embodiment, the insertion of the product is particularly simple and clean, since the double flap is adhered to the product (or at least a shows a coefficient of friction, which can adhere the double flap to the product) and then by introducing the product into the interior is disposed together with the product. The package can be held particularly securely and stably because it is held by three fingers of the user's hand. The opening is particularly suitable for the product to be “met”, since it is clamped by means of the spreading element. Closing is also particularly easy by pressing the flap into the interior, then activating the coupling element and close the opening by means of the coupling element.

A packaging with a packaging closure in accordance to the invention is particularly suitable to be used in the following exemplary areas: medical laboratories, forensics, pathology, personal hygiene and other applications where a one-handed opening and closing a packaging is advantageous.

In the area of application of forensic laboratories and pathology collection of samples is often performed manually. For this purpose, instruments are used that are operated with at least one hand. These instruments, for example, include tweezers, scrapers, cutting tools and the like. A sample which has been taken up with such an instrument is intended for being packed in many applications. Packaging that may be opened and closed with one-hand offers the advantage that the operator does not need to put down neither the sample nor the instrument to prepare the packaging for the insertion. The invention enables a packaging without preparatory measures to be put in the state for immediate insertion of a sample or the like, and to close it then.

In the application fields of personal hygiene, the invention provides a simple and clean solution for receiving a menstrual protection (e.g. tampons, pads, etc.) or non-menstrual panty liners. Menstrual pads, incontinence pads and panty liners have adhesive surface and are therefore an example of a product with an adhesive or sticky surface which can be particularly advantageously disposed of in a package according to the invention with double flap. Chewing gums are also an example of a product with an adhesive surface.

The disposal of such is often via the sewer system or the trash without sanitary bags provided for this purpose. The known hygiene bags have the disadvantage that the application must be prepared so far as the hygiene bags are kept open. The feeding of the menstrual protection is done with one hand. The other hand is often not enough to keep open the menstrual bag, which may lead to unwanted misplacement. The invention offers an advantage in so far that the operator has to make no preparations for opening a packaging and the packaging is in the open state at the desired time. Furthermore, the package of the invention offers the advantage to prevent an unpleasant odor, as the product (the used tampon, napkin, panty liner, nappy, etc.) and possibly the flap if it was in contact with the product is included in the interior of the package.

The industrial sector also offers advantages in the one-handed operation of packaging products (such as precision engineering products, which are packed by hand). As mentioned above, the invention may be used in a variety of applications and is beneficial and not limited to the examples described herein. In particular, it is not necessary that the packaging closure according to the invention is operated with one hand, but an operation by a machine or different, in particular mechanical device is also possible.

In a preferred embodiment, the first side panel comprises the flap and a coupling-element-flap, wherein the coupling element is arranged on the inside of the coupling-element-flap. Preferably, the coupling element is arranged between the flap and the coupling-element-flap. Preferably, the coupling element is positioned on an outer side of the flap or the inside of the coupling-element-flap. In a preferred embodiment, the coupling-element-flap is integrally formed with the first side panel and the flap (or double flap) is glued, welded or the like to the first side panel and/or the coupling-element-flap. In an alternative embodiment, the flap (or at least the first layer (optionally the second layer of the double flap)) is formed integrally with the first side panel and the coupling-element-flap is coupled, glued, welded or the like to the first side panel and/or the flap (or at least the first layer (and optionally the second layer) of the double flap).

In a further preferred embodiment, the spreading element is the coupling-element-flap or respectively the coupling-element-flap is the spreading element. Such an embodiment is referred to herein as “spreading coupling-element-flap”. Preferably, the spreading element is glued, welded or the like as a coupling-element-flap to the first side panel. Preferably, the spreading element comprises the coupling element. In a preferred embodiment, the spreading element is a part of the zipper (in the manner of a lock as it is common in freezer bags). Preferably, the spreading element thus performs both the function of the spreading as well as coupling element.

In a preferred embodiment, the coupling element is an adhesive element that is arranged at the inner side of the coupling-element-flap. Preferably the coupling-element-flap is glued, welded, mechanically locked etc to the flap and/or the first side panel. It is further portable that the coupling-element-flap is integral with the first side panel. Advantageously it is achieved by positioning the coupling element outside the area of the flat respectively the area of the first side panel, that the flat can be fully pushed into the interior and then the opening of the packaging can be sealed with the second side panel. Coupling the coupling element to the second side panel insures the sealing of the opening. In a preferred embodiment, the second side panel may comprise a counter-coupling element.

In a preferred embodiment, the packaging comprises a counter-coupling element that is arranged at the inside of the second side panel and is configured to couple itself with the coupling element. In a preferred embodiment the packaging comprises a further spreading element and a counter-coupling element which is arranged at the inside of the further spreading element and which is configured as to couple itself with the coupling element. Preferably the further spreading element is arranged at the second side panel (for example glued, welded or the like) or is formed of one piece of material.

It is noted that the present embodiments show at least one spreading element at/on the first side panel (or is integral with the side panel), but that the invention is not limited to these embodiments. It could be preferred that at least one spreading element is arranged only at/on the second side panel or is integral to the second side panel.

Preferably, the coupling bond is a releasable coupling bond. Preferably, the coupling is a mechanical or chemical bonding.

In a preferred embodiment the coupling element and the counter-coupling element are configured as to form a mechanical bonding. Preferably it is achieved that an unintended coupling can be prevented or avoided as the coupling element can only form a bonding with the counter-coupling element. For example, this is the case with Zip locks or grip seals. In such an embodiments, the coupling element is a first part of the zip lock or grip seal or Velcro and the counter-coupling element is a second part of a zip lock or grip seal or Velcro.

In a preferred embodiment, the flap and/or coupling-element-flap is formed integrally with the first side panel. Advantageously a simple production of the package can be achieved, since only one of the two elements “flap” and “coupling-element-flap” is glued, welded or the like on the first side panel.

Preferably, the flap and the first side panel are integrally formed, whereby a particularly simple manufacture of the package is achieved. In an alternative embodiment, the flap is disposed on the first side part, preferably glued, welded or the like.

In a preferred embodiment, the flap comprises a first fold, wherein the first fold is arranged between the first side part and the flap.

The first and/or second side panel are preferably formed of plastic. Preferably, the first and/or second side panel are made of paper. Mixed forms of the mentined materials are preferred as well. The spreading element is preferably formed from plastic or metal. Depending on the area of the packaging according to the invention, the side panels, coupling elements, flap, coupling-element-flap and/or spreading element can also be configured from other material known to experts for this purpose.

In a preferred embodiment, the coupling element is arranged on the outer side of the flap. Preferably, the coupling element is provided directly on the outer surface of the flap. Preferably, the coupling element is an adhesive element. A particularly simple structure of the packaging according to the invention is advantageously achieved. Advantageously, pressing the flap into the interior space, whereby the coupling element that is facing the opening of the package is coupled with the second side panel, connects the coupling element and thus the opening is closed.

In a preferred embodiment, the first side panel, the second side panel, the flap and/or the coupling element, comprises the spreading element (or the spreading elements). In a preferred embodiment, the coupling element and/or the counter-coupling element is a spreading element (or the spreading elements). In a further preferred embodiment, the coupling element and/or the counter-coupling element comprise the spreading element (or the spreading elements).

Further embodiments are preferred, where the packaging has multiple spreading elements. Advantageously, the opening of the interior is clamped by the spreading element, which makes it easier for the user to place the product in the packaging. The clamping is inventively achieved by applying force to the spreading element. The force is preferably applied by the above-explained holding of the packaging in the lateral area(s) of the clamping element(s), which are preferably arranged in the region of the opening, whereby the one-handed operation is facilitated. By holding the packaging it is preferably set into a stage of readiness for activation. If the user wants to open the packaging to introduce the product, the user applies force to the spreading element, thereby opening the package is supported. Opening of the package is advantageously facilitated by the spreading element as the spreading element deflects the first/second or both side panels to the outside taking the opening as a reference point. The side panel(s) form(s) by means of the corresponding force in the spreading elements an arc/oval, whereby the opening area advantageously increases, making the insertion of the product further simplified. Further, the advantage is achieved that the deflection of the first side panel by means of the spreading element can also affect the shape of the flap, so that in a preferred embodiment, the flap forms a slide, as long as the spreading element is enabled (i.e. is under the action of force). The arc-shaped flap is advantageously used as a “chute” for the product to be introduced into the packaging. The spreading element may be provided on the flap and/or the coupling-element flap, whereby similar advantages can be achieved.

In a preferred embodiment, the clamping element is a particularly elastic rod. By “rod” a body is meant, which is made long in relation to its cross-section. The rod preferably has a round cross section. In a further preferred embodiment, the coupling element comprises the spreading element. The coupling element preferably comprises a separate spreading element (in particular the “rod”). In a further preferred embodiment, the spreading element is a flat label. A flat label is a body that has, relative to its height and width, a small depth (thickness). It is also preferred that the coupling-sensitive element itself takes over the function of the spreading element when it is an adhesive element, a velcro or a zip lock or grip seal, which is configured to span the opening. Also, a label provided on the packaging can serve as a spreading element. In a preferred embodiment, the spreading element is a flat piece of plastic and/or cardboard.

In a preferred embodiment, the first side panel, second side panel, the flap, the coupling element, the coupling-element-flap and/or the counter-coupling element is a spreading element for spreading of the opening. The longitudinal axis of the spreading element is preferably aligned parallel to the opening area. Preferably, the first and/or second side panel is reinforced in a area of the opening so that this area acts as a spreading element. In a preferred embodiment, the spreading element is adapted to be forcibly bent along its longitudinal axis in the direction perpendicular to the longitudinal axis. Preferably, the spreading element is configured to receive the force in the direction of the longitudinal axis and to flex under the action of force in the direction perpendicular to the longitudinal axis.

In a preferred embodiment, the flap comprises a gripping surface for a hand. It can also be preferred that the flap is adapted to a mechanical device that causes the opening of the package by pulling the flap. The gripping surface is preferably configured to receive at least one human finger.

In a preferred embodiment the recess is a cross die cut. The recess may also be a circular, oval or otherwise shaped hole.

In a preferred embodiment, the coupling element is an adhesive element. Preferably, the coupling element is an adhesive element which is adapted to releasably adhere. An externally arranged coupling element on the first side panel, in particular a adhesive member is configured to connect the first and second side members with each other in the terminal state. It is advantageous that the coupling element arranged outside on the first side panel can connect to the second side panel for enclosing the flap after insertion of the product into the interior.

In a further preferred embodiment, the coupling element is configured such that an adhesion is achieved only if the coupling element and the counter-coupling element are brought together (in the manner of a Velcro fastener), thus, to prevent the coupling element accidentally adhering at a non-intended or for the use of the packaging impractical area.

In a further preferred embodiment, the coupling element is a so-called zip-lock or grip lock. This offers similar advantages as the seal describes such a Velcro. By the term “coupling element” all closure mechanisms are referred to, which can cause the effect of features of sealing of the opening described in the present application. Also preferred are those closure mechanisms which can bring about a releasable adhesion of the coupling element in the initial state and a non-releasable closure of the opening in the terminal state.

In a further preferred embodiment, the tab is formed asymmetrically. Preferably, the recess is disposed closer to a side of the opening than to the other side of the opening. Advantageously, so the design of the packaging is adjusted to different hand sizes and the usability for right handed and left handed users.

In a further aspect, the invention relates to a packaging closure of a packaging according to the invention. Within the scope of the invention it is included, that packages with a packaging closure of the invention may be retrofitted. Such a package closure according to the invention, at least the flap with the recess, the spreading element and the coupling element, such as are described herein with reference to the packaging.

In a further aspect, the invention relates to a method for manufacturing a package for receiving a product comprising the steps of: providing a first side panel and a second side panel for forming an inner space of the package and forming an opening of the interior space for receiving the product, providing a flap on the first side panel, providing a recess for receiving a finger, providing a spreading element for spreading said opening and providing an coupling element on an outer side of the flap and/or of the first side panel for closing the opening.

In a further aspect the invention relates to a sales packaging for the inventive packaging whereas the sales package includes at least a first packaging and a second packaging, wherein the flap of the second packaging is arranged over the opening of the second packaging and on the outer side of the flap of the second packing is releasably adhered to the first packaging (connected chemically or mechanically) and in particular releasably adhered to the spreading element of the first packaging.

In addition to the aspects and embodiments described above, the following aspects and embodiments for packaging with double flap within the scope of the present application are included:

In a further aspect, the invention relates to a packaging for containing a product comprising: a first side panel and second side panel, wherein the first and second side panel form an internal space of the packaging and an opening of the interior space for receiving the product, a double flap disposed on the first side part and has a recess for receiving a finger, and at least one spreading element for spreading of the opening.

In one embodiment, the packaging further comprises a coupling element for sealing the opening, wherein the coupling element is disposed on an outer side of the double flap and/or of the first side panel.

In one embodiment, the first side panel comprises a double flap and a coupling-element-flap, wherein the coupling element is arranged on the inside of the coupling-element-flap.

In one embodiment, the packaging further comprises a counter-coupling element, which is arranged on an inner side of the second side panel, and is configured to respond to the coupling element with an coupling connection.

In one embodiment, the packaging further comprises a further spreading element and a counter-coupling element, which is arranged on an inner side of the other spreading element and is configured to respond to the adhesive member with an adhesive connection.

In one embodiment, the double flap and/or the coupling-element-flap is formed integrally with the first side panel.

In one embodiment the spreading element is a coupling-element-flap.

In one embodiment, the coupling element is a first part of a zipper or grip seal or Velcro and the counter-coupling element is a second part of the zipper, grip seal or Velcro.

In one embodiment, the first side panel, the second side panel, the double flap and/or the coupling-element-flap, the spreading element on and/or the coupling element and/or the counter-coupling element, the clamping element comprises the spreading element.

In a further aspect, the invention relates to a method for producing a packaging with a double flap for receiving a product, comprising the steps of: providing a first side panel and a second side panel for forming an interior of the packaging and forming an opening of the interior space for receiving the product, provision of a double flap on the first side panel, providing a recess for receiving a finger in the double flap and providing at least one spreading element for spreading the opening.

Hereinafter, preferred embodiments of the invention will be exemplified by means of figures, wherein

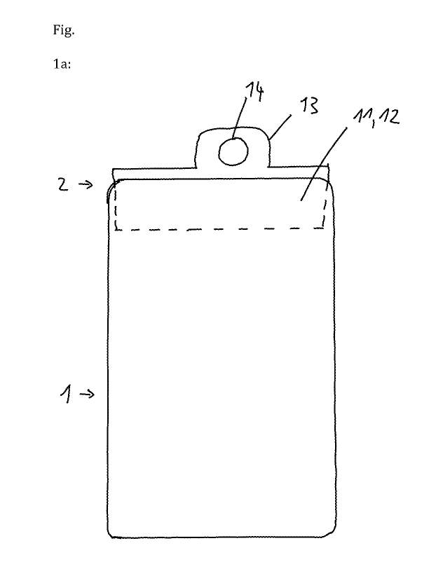

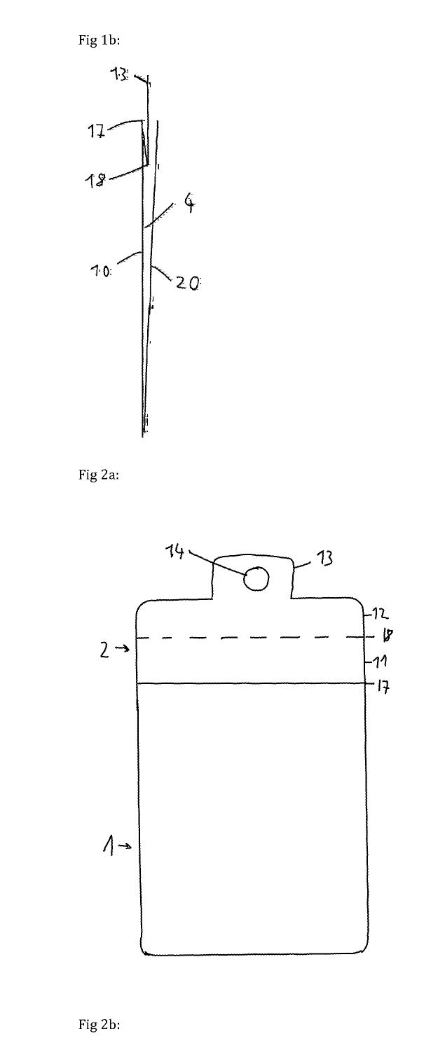

FIG. 1A shows a first preferred embodiment of a packaging according to the invention in the initial state in plan view;

FIG. 1b shows the first preferred embodiment of a packaging according to the invention in cross section;

FIG. 1c shows a detailed view of the first preferred embodiment of a packaging according to the invention in cross-section;

FIG. 2A shows a second preferred embodiment of a packaging according to the invention in the initial state in plan view;

FIG. 2B showing a second preferred embodiment of a packaging according to the invention in cross section;

FIG. 2c shows a detailed view of a second preferred embodiment of a packaging of the Invention in cross-section;

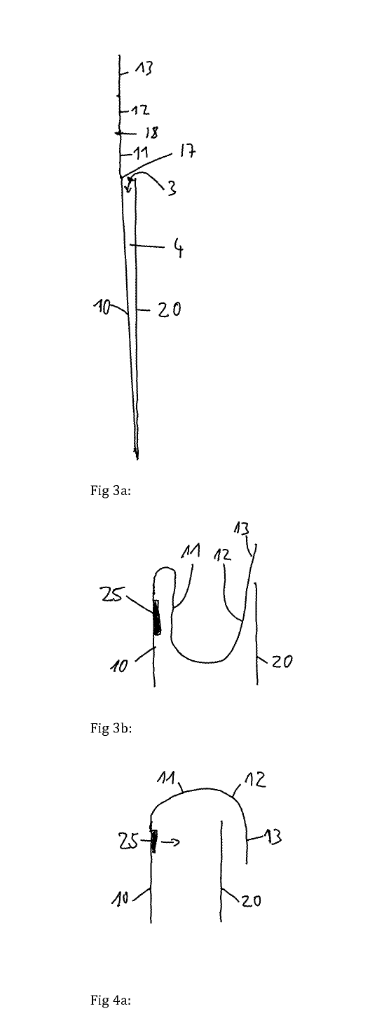

FIG. 3a shows a third preferred embodiment of an inventive packaging with arrangement of a counter-coupling element in cross-section;

FIG. 3b shows a detail view of a third preferred embodiment of an inventive packaging with arrangement of a counter-coupling element in the initial state in cross-section;

FIG. 3c shows a detailed view of a fourth preferred embodiment of the invention with a packaging arrangement of a counter-coupling element in the initial state in cross-section;

FIG. 3d shows a detailed view of the third preferred embodiment of the invention with a packaging arrangement of a counter-coupling element in the final state in cross-section;

FIG. 3e shows a fifth preferred embodiment of an inventive packaging with an integral coupling element/coupling-element-flap;

FIG. 3f shows a detailed view of the fifth preferred embodiment of an inventive packaging with an integral coupling element/coupling-element-flap;

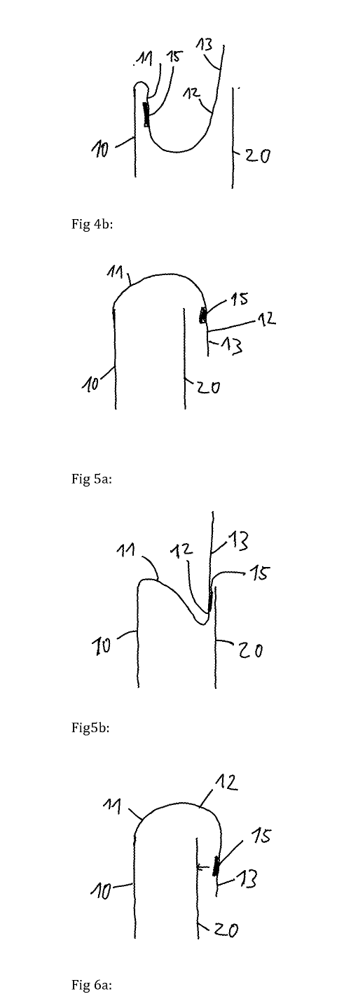

FIG. 4 shows an example of a manufacturing process for producing a packaging according to the invention with an arrangement of a counter coupling element and a combined spreading element and coupling-element-flap;

FIG. 5a shows a preferred embodiment of an inventive packaging for sale of packaging according to the invention in a state of storing packaging;

FIG. 5b shows the preferred embodiment of the sales packaging of the invention in a state of withdrawal of one of the packaging according to the invention;

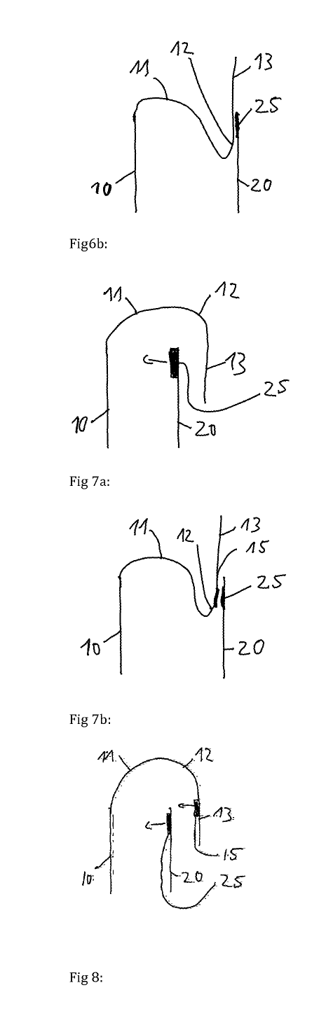

FIG. 6 illustrates the one-handed operation of a packaging according to the invention;

FIG. 7a shows a sixth preferred embodiment of a packaging according to the invention with a double flap, in plan view displays;

FIG. 7b, shows the sixth preferred embodiment of a packaging according to the invention with a double flap is in the cross-section;

FIG. 7c shows a detailed view of the sixth preferred embodiment of an inventive packaging with double flap in cross-section;

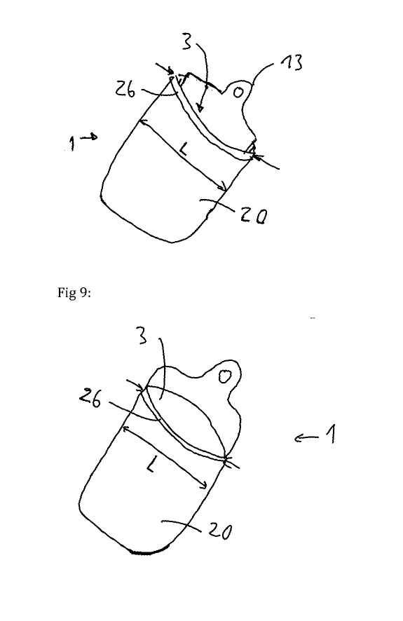

FIG. 8a shows a seventh preferred embodiment of an inventive packaging with double flap in top view;

FIG. 8b shows the seventh preferred embodiment of a packaging according to the invention with a double flap is in the cross-section;

FIG. 8c shows a detailed view of the seventh preferred embodiment of an inventive packaging with double flap in cross-section;

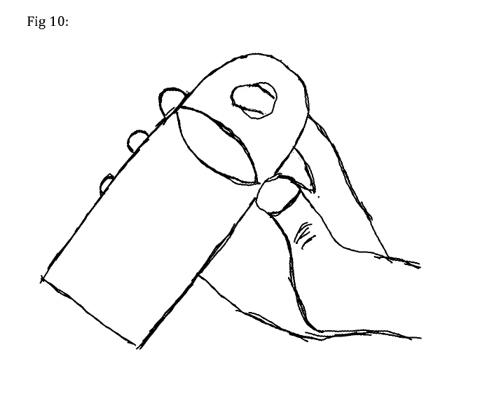

FIG. 9a shows an eighth preferred embodiment of an inventive packaging with double flap and arrangement of a counter-coupling element in cross section;

FIG. 9b shows the eighth preferred embodiment of an inventive packaging with double flap and arrangement of a counter-coupling element in the initial state in cross section;

FIG. 9c shows a detailed view of the eighth preferred embodiment of an inventive packaging with double flap and arrangement of a counter-coupling element in the initial state in cross section;

FIG. 9d shows a ninth preferred embodiment of an inventive packaging with double flap and arrangement of an adhesive member in the initial state in cross section;

FIG. 9e shows a detailed view of the ninth preferred embodiment of an inventive packaging with double flap and arrangement of a counter coupling element in the initial state in cross section, and

FIG. 10 illustrates an example of the proper use of an inventive packaging with double flap.

In the following, various embodiments of the arrangement of coupling element(s) 15, spreading element(s) 26 and coupling-element-flaps 11 and combined spreading coupling-element flaps 11 are explained, but the invention is not limited to these, but these only serve as exemplification. Although in the following, numbers (first, second, third, etc. embodiment), distinguish between the embodiments, the features of the embodiments may be combined. Reference numerals designate identical or analogous features are not explained for each embodiment in order to avoid repetition, but it is hereby made to the corresponding explanations of the features and reference numerals.

The embodiments shown have in common that the coupling element(s) 15 (alternatively or additionally: the coupling elements 15 and 25) is/are configured for closing the opening 3 when the flap 13 is disposed in the interior 4. Furthermore, the embodiments shown have in common that the coupling element 15 is disposed on an outer side of the tab 13 and/or the first side panel 10.

FIG. 1a shows a packaging 1 of the invention with a packaging closure according to the invention. The package closure has an integrally formed flap 13 with the first side panel 10. The flap 13 has a recess 14 into which a human finger can be inserted, as shown in FIG. 6. In the embodiment shown in FIG. 1a, the recess is a cross die cut 14. On the outer side of the flap 13 an adhesive member 15 is disposed.

FIG. 1a shows the initial state of the packaging 1 as an example, in which FIG. 1b is a side view of it. The package 1 has a first side panel 10 and a second side panel 20, which form between them the space 4 with the opening 3 of the interior 4 of the packaging 1. In the embodiments of the inventive package 1 shown in FIGS. 1b and 1c, a spreading element 26 and 36 and a coupling element 15 is arranged on the outer sides of the side parts 10 and 20 and on the outer side of the tab 13 respectively.

FIGS. 2a, 2b and 2c illustrate a preferred embodiment of a packaging according to the invention 1 in the initial state with a coupling-element-flap 11, wherein the adhesive member 15 is arranged on the inner side of the coupling-element-flap 11, and is arranged on the outer side of the flap 13, and a spreading element 26 and 36 for spreading the opening 3. FIG. 2a shows a flap 13 having a recess 14 for receiving a finger, whereby in this embodiment the recess 14 is a cross die cut. FIG. 2c shows a detailed view of FIG. 2b, showing a coupling element 15 that is arranged at the inside of the coupling-element-flap 11 and is detachably connected to the outside of the flap 13.

FIGS. 3a, 3b, 3c, 3d, 3e and 3f illustrate the preferred embodiments of a package according to the invention 1 with an coupling-element-flap 11, the coupling element 15 is disposed on the inner side of the coupling-element-flap 11, and is disposed on the outer side of the flap 13, and a spreading element 26 and 36 for spreading the opening 3 and a counter-coupling element 25 which is configured to respond with the coupling element 15 as a coupling bond. FIGS. 3c, 3e and 3f show preferred embodiments in which the counter-coupling element 25 is disposed on an inner side of the second side panel 20. FIGS. 3a, 3b and 3d show preferred embodiments in which the counter-coupling element 25 is disposed on an inner side of a second spreading element 36. FIGS. 3a, 3b and 3c show preferred embodiments of a packaging according to the invention 1 in the initial state. FIG. 3d shows a preferred embodiment of an inventive packaging 1 in the final state.

FIGS. 3e and 3f illustrate a preferred embodiment of a packaging according to the invention 1, wherein coupling element 15 is formed integrally with the coupling-element-flap 11 in which the spreading elements 26 and 36 are arranged on the side panel 10, 20.

In a further embodiment, not shown, the coupling-element-flap 11 having the adhesive member 15 having is integrally formed with the first side panel 10. For example, the package 1 is in a preferred embodiment a grip seal bag, wherein the grip seal form the coupling element 15 and the counter-coupling element 26, with the clamping elements 26, 36 being flat plastic strips that are bonded parallel to and close to the opening on the side panels 10, 20 of the bag, and wherein the flap 13 that has a circular recess 14, is glued to the inside of the first side member 10.

FIG. 4 illustrates an example of a manufacturing process of a package 1. FIG. 4 shows the components, how they are placed against each other and result in such a preferred embodiment of an inventive packaging 1. This exemplary embodiment in FIG. 4 has a spreading element 26 and 36 for clamping the opening 3 and a counter-coupling member 25, and an coupling element 15, which is arranged on an inner side of a coupling-element-flap 11, wherein the coupling-element-flap 11 and the spreading element 26 form a spreading coupling-element-flap 22. The preferred embodiments of the figures described herein, as well as other embodiments may of course also have a spreading coupling-element-flap 22, as it is exemplified in the embodiment of FIG. 4.

FIGS. 5a and 5b show, how a first preferred embodiment (shown in FIGS. 1a, 1b, 1c) of a packaging 1 according to the invention is packed in a sales packaging according to the invention. 5a shows packaging 1 of the invention, the coupling element 15 of a subordinately stored package 1 is adhered to the clamping element 26 of the primary stored package 1, and wherein a tab 13 of each subordinately packed package 1 is located above the opening 3 of the packaging 1, and an inside of a flap 13 is applied to an outer side of a second side panel 20. FIG. 5b shows the state of the removal of the primary stored package 1, which is pulled or raised from the sales package and a tab 13 of a subordinated mounted package pulls with it or raises. A coupling element 15 of a subordinately packed packaging is thereby released by a spreading element 26 of the primarily stored package.

FIG. 6 illustrates how a preferred embodiment of an inventive packaging 1 is held at three points with the thumb, index finger and the middle finger of one hand, and how the opening 3 of the package 1 is opened by pressure of the thumb and middle finger on the clamping elements 26 and 36, of and how by pulling of the index finger, the flap 13 is formed as a slide.

FIG. 7a shows a package 1 of the invention with a packaging closure according to the invention. The package seal has a one-piece (ie on a piece of material) double flap 13, 23. The double flap has a first flap 13, and a second flap 23 and a recess 14 into which a human finger can be inserted, as shown in FIG. 6. In the embodiment shown in FIG. 7a, the recess is a cross die cut 14. A pressure element 15 is arranged on the outer side (as shown in FIG. 7b) of the double flap 13, 23.

In FIG. 7a, the initial state of the package 1 is shown as an example, wherein FIG. 7b is a side view, which shows in section. The package 1 has a first side panel 10 and a second side panel 20, which form between them the interior 4 with the opening 3 of the interior 4 of the package 1. In the embodiment of the inventive package 1 shown in FIGS. 7b and 7c, a spreading element 26 and 36 and a coupling element 15 is arranged on the outer sides of the side parts 10 and 20 and on the outer side of the tab 13 respectively.

FIGS. 8a, 8b and 8c illustrate a further preferred embodiment of a package according to the invention 1 in the initial state with a coupling-element-flap 11, wherein the coupling element 15 is disposed on the inner side of the coupling-element-flap 11 and on the outer side of the flap 13. The packaging further comprises spreading elements 26 and 36 for spreading the opening 3. FIG. 8a shows a double flap 13, 23 with a recess 14 for receiving a finger, whereby in this embodiment the recess 14 is a cross die cut. The double flap has a first flap 13 and a second flap 23. 8c shows a detailed view of FIG. 8b showing an coupling element 15, which is arranged on the inside of the coupling-element-flap 11 and is detachably connected to the outside of the flap 13. “Detachably” means in the present case for example, a “releasable adhesive bond” (in particular, when the coupling element is an adhesive member), or a “touching” (particularly where the coupling element is a mechanical gripping element, for example a grip seal).

FIGS. 9a, 9b , 9c, 9d and 9e illustrate the preferred embodiments of a packaging according to the invention 1 with a coupling-element-flap 11, wherein a coupling element 15 is arranged on the inside of the coupling-element-flap 11 and the outside of the double flap 13, 23. Furthermore, the packaging comprises spreading elements 26 and 36 for spreading the opening 3 and a counter-coupling element 25, which is configured to respond with the coupling element 15 as bond. FIGS. 9d and 9e show a preferred embodiment in which the counter-coupling element 25 is disposed on an inner side of the second side panel 20. FIGS. 9b and 9c show preferred embodiments in which the counter-coupling element 25 is disposed on an inner side of a second spreading element 36.

In a non-shown embodiment, the coupling-element-flap 11 and spreading element 26 are formed as a combined spreading coupling-element-flap 22 (the coupling-element-flap 11 is thus the spreading element 26, or vice versa).

FIG. 10 shows a process of the intended use of a packaging according to the invention with double flap. The embodiment of FIG. 10 comprises spreading elements 26 and 36 for spreading the opening 3 and a counter-coupling element 25 and a coupling element 15. The double flap has a first flap 13 and second flap 23. In the left drawing of FIG. 10, the packaging is in the initial state. To introduce an adhesive or sticky product 40 into the package, the user moves the finger 45 (preferably an index finger) into the recess 14 (arrow 1). At the same time the user presses the thumb and middle finger on the side edges of the spreading elements, but this is not illustrated in FIG. 10, since it is a cross-sectional view. The product 40 adheres when in contact with the second flap 23 or sticks due to a friction coefficient corresponding to the second flap 23. Since the finger 45 is still in the recess 14, neither the second tab 23 still adhering to the product 40 can move in the direction of the interior 4. When the user pulls his finger from the recess 14, the movement of the second flap 23 is released (arrow 2). The product 40 falls into the interior 4 of the package and pulls the second strap 23 with it until the first tab 13 is also moved into the interior 4 (arrow 3). When the two flaps 13, 23 are placed entirely in the interior 4, the packing can be closed by the coupling element 15 and the counter-coupling element 25.

1. Packaging (1) for receiving a product comprising
a first side panel (10) and a second side panel (20), wherein the first and the second side panel (10, 20) form an opening (3) of an interior (4) of the packaging (1) for receiving the product,
a flap (13), which is arranged at the first side panel (10) and comprises a recess (14) that in configured to receive a finger,
at least one spreading element (26) for spreading the opening (3), and one coupling element (15) configured to close the opening (3), wherein the coupling element (15) is arranged on an outer side of the flap (13) and/or the first side panel (10).

2. Packaging (1) according to claim 1, wherein the first side panel (10) comprises the flap (13) and a coupling-element-flap (11), wherein the coupling element is arranged on the inner side of the coupling-element-flap (11).

3. Packaging (1) according to claim 1 or 2, wherein the packaging (1) comprises a counter-coupling element, which is arranged on an inner side of the second side panel (20) and is configured to form a bond with the coupling element (15).

4. Packaging (1) according to claim 1 or 2 wherein the packaging (1) comprises a counter-coupling element, which is arranged on an inner side of a second spreading element (36), which is arranged on the second side panel (20) and is configured to form a bond with the coupling element (15).

5. Packaging (1) according to any one of the preceding claims wherein the flap (13) and/or the coupling-element-flap (11) is integral to the first side panel (10).

6. Packaging (1) according to any one of the preceding claims wherein the coupling element (15) is integral to the coupling-element-flap (11).

7. Packaging (1) according to any one of the preceding claims wherein the spreading element (26) is the coupling-element-flap (11).

8. Packaging (1) according to any one of the preceding claims wherein the flap (13) as a double flap (13,23) comprises a first layer (13) and a second layer (23)

9. Packaging (1) according to claim 7 wherein the first layer (13) and the second layer (23) are connected with an edge

10. Packaging (1) according to claim 7 or 8 wherein the double flap (13,23) is made of one piece of material and comprises a fold between the first layer (13) and the second layer (23)

11. Packaging (1) according to any one of the preceding claims wherein the coupling element (15) is an adhesive element

12. Packaging (1) according to any one of the preceding claims wherein the coupling element (15) and the counter-coupling element (25) are configured to form a mechanical bond.

13. Packaging (1) according to claim 12 wherein the coupling element (15) is a first part of a grip seal or Velcro and the counter-coupling element is a second part of a grip seal or Velcro.

14. Packaging (1) according to any one of the preceding claims wherein the first side panel (10), the second side panel (20), the flap (13) and/or the coupling-element-flap (11) comprises the spreading element (26).

15. Packaging (1) according to any one of the preceding claims wherein the coupling element (15) and/or the counter coupling element (25) is the spreading element (26) or comprises the spreading element (26).

16. Packaging (1) according to any one of the preceding claims wherein the recess (14) is a cross die cut.

17. Method of manufacturing of a packaging (1) for receiving a product with the steps:
providing a first side panel (10) and a second side panel (20) for forming an interior (4) of the packaging and forming an opening (3) of the interior for receiving the product,
providing a flap (13) on the first side panel (10),
providing a recess (14) for receiving a finger in the flap (13),
providing a spreading element (26) for spreading the opening (3) and
providing an coupling element (15) on an outer side of the flap (13) and/or of the first side panel (10) for closing the opening (3).
